(19) United States
(12) Patent Application Publication
(10) Pub. No.: US 2016/0104228 A1
(43) Pub. Date: Apr. 14, 2016

(54) BOTTOMLESS INVENTORY INTERFACE

(71) Applicant: eBay Inc., San Jose, CA (US)

(72) Inventor: Neelakantan Sundaresan, Mountain View, CA (US)

(21) Appl. No.: 14/514,301

(22) Filed: Oct. 14, 2014

(51) Int. Cl. G06Q 30/06; G06Q 30/08

(52) U.S. Cl. CPC G06Q 30/0625; G06Q 30/0611; G06Q 30/0643; G06Q 30/08

(57) ABSTRACT

The present disclosure is directed to apparatuses, systems, and methods for providing a presentation layer to present a “bottomless” inventory of products or items to client device users. In response to not identifying a product or item listing to satisfy a user search query, embodiments can transmit an offer, from the user, to buy the product or item to one or more vendors to accept, thereby proactively fulfilling the user's request for the product or item even in the absence of inventory for the product or item. These vendors can comprise vendors utilizing physical retail locations, online-only vendors, etc. The vendors can receive the user's offer to buy the product or item in real time or near-real time.

### TECHNICAL FIELD

The present application relates generally to the technical field of data processing and, in some examples, to proactively fulfilling requests for items or products regardless of inventory location.

### BACKGROUND

Online publication systems, such as electronic marketplaces, as well as offline vendors at physical retail locations, can offer a wide variety of items and/or services for sale. An electronic marketplace can be accessed using a web browser, such as Google Chrome, Mozilla Firefox, Microsoft Internet Explorer, and other such web browsers. The electronic marketplace can accept search queries via the web browser to help a user find a particular offered product or item, such as a good or service.

There are many occasions in both online and offline shopping experiences when a user can find no inventory or availability for a particular good or service of interest. Examples for online publication systems include: a return of no search results in response to a search query, product listings for a search query consisting of only expired item listings or expired auctions, etc. For offline vendors, a user can find no inventory of a desired product or item as a result of the vendor not having the product or item at its physical retail location. When users find no inventory for their items of interest, they can leave the online/offline site and be discouraged from returning in the future. Thus, an “out of inventory” listing can result in lost sales.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 illustrates a network architecture of an exemplary system according to aspects of the disclosure.

FIG. 2 illustrates exemplary applications executable by one or more application servers according to aspects of the disclosure.

FIG. 3 illustrates an exemplary client machine according to aspects of the disclosure.

FIG. 4 is a block diagram illustrating components of a machine, according to some example embodiments, able to read instructions from a machine-readable medium and perform any one or more of the methodologies discussed herein, according to aspects of the disclosure.

FIG. 5 illustrates a webpage of a publication system configured to publish item listings according to aspects of the disclosure.

FIG. 6 is another web page of a publication system displaying search results in response to a received search query according to aspects of the disclosure.

FIG. 7 is an illustration of a system for providing a bottomless inventory interface according to an embodiment.

FIG. 8 illustrates an exemplary logic flow for presenting a bottomless inventory for received search queries according to aspects of the disclosure.

FIG. 9 illustrates an exemplary logic flow for processing a received user-generated offer to buy a product according to aspects of the disclosure.

FIG. 10 illustrates an exemplary logic flow for submitting a user-generated offer to buy a product according to aspects of the disclosure.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter can be practiced without these specific details. In general, well-known instruction instances, protocols, structures, and techniques have not been shown in detail.

The present disclosure is directed to apparatuses, systems, and methods for providing a presentation layer to present a “bottomless” inventory of products or items to client device users. In response to not identifying a product or item listing to satisfy a user search query, embodiments can transmit an offer to buy the product or item to one or more vendors to accept, thereby proactively fulfilling the user's request for the product or item even in the absence of inventory for the product or item.

The methods or embodiments disclosed herein can be implemented as a computer system having one or more modules (e.g., hardware modules or software modules). Such modules can be executed by one or more processors of the computer system. The methods or embodiments disclosed herein can be embodied as instructions stored on a machine-readable medium that, when executed by one or more processors, cause the one or more processors to execute the instructions.

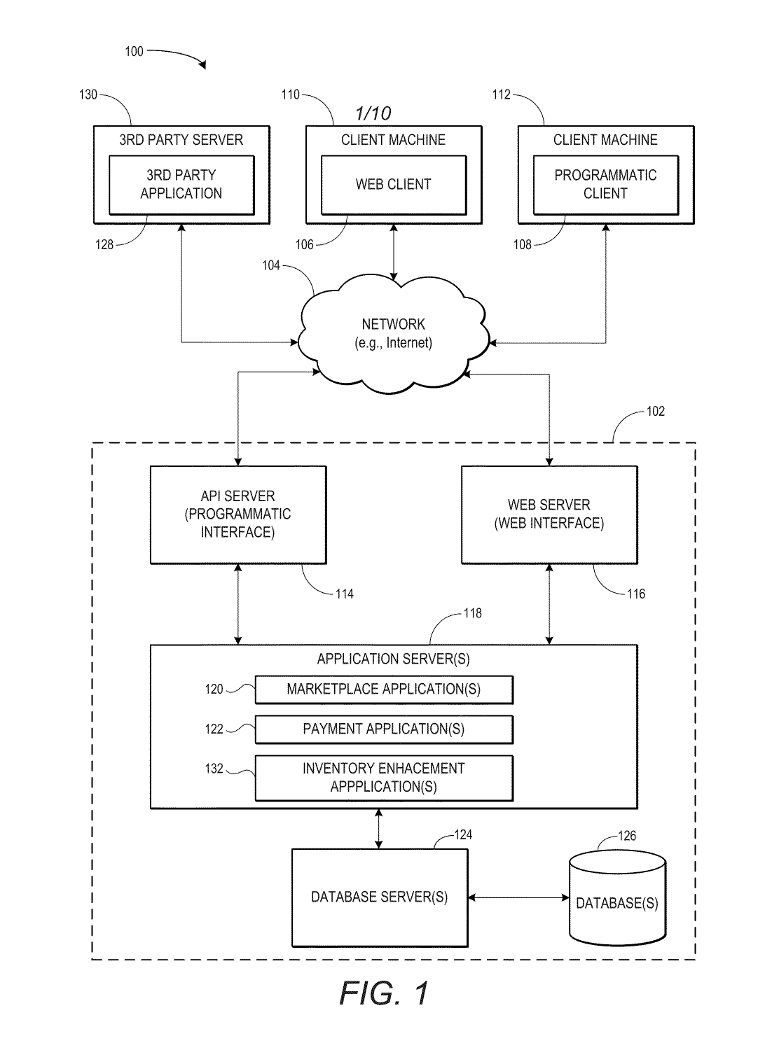

FIG. 1 is a network diagram depicting a client-server system 100 according to aspects of the disclosure. A networked system 102, in the example forms of a network-based marketplace or publication system, provides server-side functionality, via a network 104 (e.g., the Internet or a Wide Area Network (WAN)) to one or more client machines. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An Application Program Interface (API) server 114 and a web server 116 are coupled to, and provide programmatic and web interfaces respectively to, one or more application servers 118. The application server(s) 118 host one or more applications, such as a marketplace application(s) 120, a payment application(s) 122, and one or more inventory enhancement applications 132. The application server(s) 118 are, in turn, shown to be coupled to one or more database servers 124 that facilitate access to one or more databases 126.

The marketplace application(s) 120 can provide a number of marketplace functions and services to users who access the networked system 102. The payment application(s) 122 can likewise provide a number of payment services and functions to users. The payment application(s) 122 can allow users to accumulate value (e.g., in a commercial currency, such as the U.S. dollar, or a proprietary currency, such as “points”) in accounts, and then later to redeem the accumulated value for products (e.g., goods or services) that are made available via the marketplace application(s) 120.

As discussed further below, the price ranges and price points can be collected from one or more sources, such as items being offered for sale through the electronic marketplace, items being offered at auctions hosted by the electronic marketplace, items having been previously sold through the electronic marketplace, external sources (e.g., application-programming interfaces to other electronic marketplaces), and other such sources. Thus, when a search query is received for items being offered for sale through the electronic marketplace, the application server(s) 118 can provide one or more price ranges for the prices of search results that correspond to the received search query.

The application server(s) 118 can also include one or more inventory enhancement application(s) 132 to present a “bottomless” inventory of products to users. As described in further detail below, one or more inventory enhancement application(s) 132 can present a “bottomless” inventory of products and/or items (i.e., goods and/or services) to users of client devices, such as the client machines 110 and 112. In response to not identifying a product or item listing to satisfy a user search query, one or more inventory enhancement application(s) 132 can transmit (e.g., via the third party server 130) an offer, generated by the user, to buy the product or item to one or more vendors to accept, thereby proactively fulfilling the user's request for the product or item even in the absence of inventory for the product or item.

While the marketplace application(s) 120, the payment application(s) 122, and the inventory enhancement application(s) 132 are shown in FIG. 1 to form part of the networked system 102, it will be appreciated that, in alternative embodiments, the applications 120, 122, and 132 can be separate or distinct from the system 102. For example, the payment application(s) 122 can form part of a payment service that is separate and distinct from the networked system 102.

Further, while the system 100 shown in FIG. 1 employs a client-server architecture, the embodiments are of course not limited to such an architecture, and could equally well find application in a distributed, or peer-to-peer, architecture system, for example. The marketplace application(s) 120, the payment application(s) 122, and the inventory enhancement application(s) 132 could also be implemented as standalone software programs, which do not necessarily have networking capabilities.

The web client 106 can access the marketplace application(s) 120, the payment application(s) 122, and the inventory enhancement application(s) 132 via the web interface supported by the web server 116. Similarly, the programmatic client 108 can access the various services and functions provided by the applications 120, 122, and 132, via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, payment, or advertising functions that are supported by the relevant applications of the networked system 102.

The networked system 102 can provide a number of publishing, listing, and price-setting mechanisms whereby a setter can list (or publish information concerning) goods or services for sale, a buyer can express interest in or indicate a desire to purchase such goods or services, and a price can be set for a transaction pertaining to the goods or services.

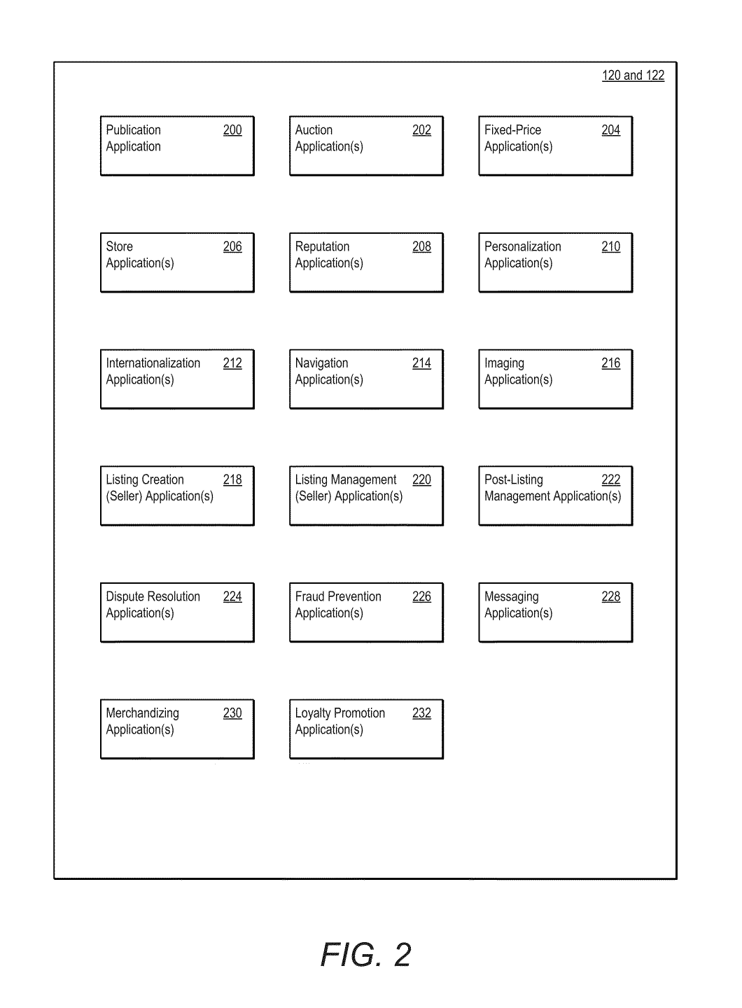

FIG. 2 illustrates exemplary applications that can be executable by the foregoing application server(s) 118 to support the aforementioned mechanisms. To this end, the marketplace application(s) 120 and the payment application(s) 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 can also provide a number of features in support of such auction-format listings, such as a reserve price feature whereby a seller can specify a reserve price in connection with a listing and a proxy-bidding feature whereby a bidder can invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) can be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which can be branded and otherwise personalized by and for the seller. Such a virtual store can also offer promotions, incentives, and features that are specific and personalized to a relevant seller.

Reputation applications 208 allow users who transact, utilizing the networked system 102, to establish, build, and maintain reputations, which can be made available and published to potential trading partners. Consider that where, for example, the networked system 102 supports person-to-person trading, users can otherwise have no history or other reference information whereby the trustworthiness and credibility of potential trading partners can be assessed. The reputation applications 208 allow a user (e.g., through feedback provided by other transaction partners) to establish a reputation within the networked system 102 over time. Other potential trading partners can then reference such a reputation for the purposes of assessing credibility and trustworthiness.

Personalization applications 210 allow users of the networked system 102 to personalize various aspects of their interactions with the networked system 102. For example a user may, utilizing one of the appropriate personalization applications 210, create a personalized reference page on which information regarding transactions to which the user is (or has been) a party can be viewed. Further, one of the personalization applications 210 can enable a user to personalize listings and other aspects of their interactions with the networked system 102 and other parties.

The networked system 102 can support a number of marketplaces that are customized, for example, for specific geographic regions. A version of the networked system 102 can be customized for the United Kingdom, whereas another version of the networked system 102 can be customized for the United States. Each of these versions can operate as an independent marketplace or can be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 can be used to support the customization of information for a number of regional websites that are operated by the networked system 102 and that are accessible via web server 116.

Navigation of the networked system 102 can be facilitated by one or more navigation applications 214. For example, a search application (as an example for one of the navigation applications 214) can enable key word searches of listings published via the networked system 102. A browse application can allow users to browse various category, catalogue, or inventory data structures according to which listings can be classified within the networked system 102. Various others of the navigation applications 214 can be provided to supplement the search and browsing applications.

In order to make the listings available via the networked system 102 as visually informing and attractive as possible, the applications 120 and 122 can include one or more imaging applications 216, which users can utilize to upload images for inclusion within listings. The imaging applications 216 also operate to incorporate images within viewed listings. The imaging applications 216 can also support one or more promotional features, such as image galleries that are presented to potential buyers. For example, sellers can pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings can present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller can wish to leave feedback regarding a particular buyer. To this end, one or more post-listing management applications 222 can provide an interface to one or more reputation applications 208, so as to allow the seller conveniently to provide feedback regarding multiple buyers to the reputation applications 208.

Dispute resolution applications 224 provide mechanisms whereby disputes arising between transacting parties can be resolved. For example, the dispute resolution applications 224 can provide guided procedures whereby the parties are guided through a number of steps in an attempt to settle a dispute. In the event that the dispute cannot be settled via the guided procedures, the dispute can be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or to providing promotional and merchandising information to users). Respective messaging applications 22.8 can utilize any one of a number of message delivery networks and platforms to deliver messages to users. For example, messaging applications 228 can deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that can be invoked by sellers, and can monitor and track the success of merchandising strategies employed by sellers.

The networked system 102 itself, or one or more parties that transact via the networked system 102, can operate loyalty programs that are supported by one or more loyalty/promotions applications 232. For example, a buyer can earn loyally or promotion points for each transaction established and/or concluded with a particular seller, and can be offered a reward for which accumulated loyalty points can be redeemed.

Furthermore, and referring back to FIG. 1, the inventory enhancement application(s) 132 can leverage one or more of the applications 200-232 in dynamically determining current inventory for items or products providing a meaningful display of this information. In other words, the inventory enhancement application(s) 132 can invoke or use data gathered by the applications 200-232 in determining item and product listings that are ultimately displayed to the user as popular price ranges. For example, the inventory enhancement application(s) 132 can obtain one or more search queries via the navigation application(s) 214, and prices for the various listings via the auction application(s) 202 and/or the fixed-price application(s) 204. The inventory enhancement application(s) 132 can also access other applications shown in FIG. 2, such as the store application(s) 206, to obtain prices for items that were previously sold.

As the inventory enhancement application(s) 132 can be integrated (e.g., directly or indirectly) with the application server(s) 118, the inventory enhancement application(s) 132 can leverage the data obtained from the applications 200-232 and provide relatively up-to-date or current price ranges for items being offered through the electronic marketplace. This integration can further extend to the one or more database server(s) 124 and/or database(s) 126 in communication with the application server(s) 1118. As discussed below, the inventory enhancement application(s) 132 can access stored information, such as session logs, to dynamically determine popular price ranges for one or more items based on one or more received search queries.

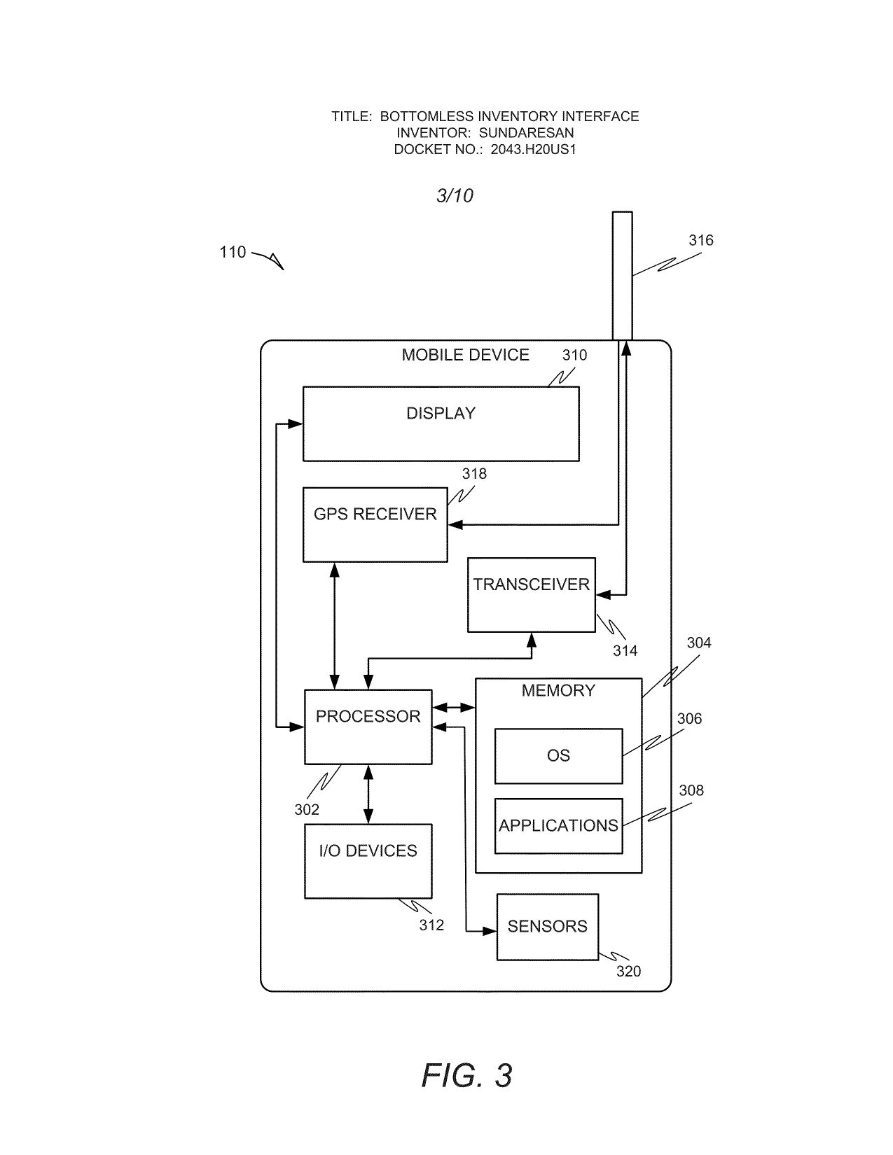

FIG. 3 illustrates one example for one of the client machines 110 in accordance with aspects of the disclosure. In one embodiment, the client machine 110 can be a mobile device, which can comprise any of a laptop computer, a tablet, a smartphone, a wearable computing device (e.g., a heads-up display (HUD) device), etc. The client machine 110 can include a processor 302. The processor 302 can be any of a variety of different types of commercially available processors suitable for mobile devices (e.g., an ARM architecture microprocessor, a Microprocessor without Interlocked Pipeline Stages (MIPS) architecture processor, or another type of processor). A memory 304, such as a random access memory (RAM), a Flash memory, or other type of memory, is typically accessible to the processor 302. The memory 304 can be adapted to store an operating system (OS) 306, as well as application programs 308, such as a mobile location enabled application that can provide location-based services to a user. The processor 302 can be coupled, either directly or via appropriate intermediary hardware, to a display 310 and to one or more input/output (I/O) devices 312, such as a keypad, a touch panel sensor, a microphone, and the like. In some embodiments, display 310 comprises a touchscreen display capable of functioning as an I/O device. Similarly, in some embodiments, the processor 302 can be coupled to a transceiver 314 that interfaces with an antenna 316. The transceiver 314 can be configured to both transmit and receive cellular network signals, wireless data signals, or other types of signals via the antenna 316, depending on the nature of the client machine 110. Further, in some configurations, a GPS receiver 318 can also make use of the antenna 316 to receive GPS signals. The client machine 110 is shown to further include one or more sensors 320 for capturing at least one of audio data (e.g., via an audio sensor such as a microphone) and/or image data (e.g., photo, video, or any other type of image data via an image sensor such as a camera).

The application programs 308 of the client machine 110 can further include one or more browser applications, such as mobile browser applications, which can be used to provide a user interface to permit the user to browse information available over the network interface. The application programs 308 can further include one or more provider-specific mobile applications (alternatively referred to herein as “mobile apps”), downloaded (e.g., downloaded by the user from a mobile software distribution platform) and resident on the client machine 110, that enable the user to access content through the mobile app in addition to said mobile browser application.

As referred to herein, mobile browsers and mobile apps can describe computer programs designed to run specifically on mobile devices such as smartphones, tablet computers, other handheld computing devices, etc. Mobile browsers and mobile apps can be designed with consideration to the constraints (e.g., low-power processors, limited memory, etc.) and features (e.g., location identification capabilities using geo-location sensors, integrated cellular telephone connectivity, etc.) of mobile devices. Mobile browsers and mobile apps can also implement mobile user interface (UI) designs that consider constraints of the screen size of the display 310, touchscreen capabilities attic display 310, etc.

Certain embodiments are described herein as including logic or a number of components, modules, or mechanisms. Modules can constitute either software modules (e.g., code embodied on a machine-readable medium or in a transmission signal) or hardware modules. A hardware module is a tangible unit capable of performing certain operations and can be configured or arranged in a certain manner. In example embodiments, one or more computer systems (e.g., a standalone, client, or server computer system) or one or more hardware modules of a computer system (e.g., a processor or a group of processors) can be configured by software (e.g., an application or application portion) as a hardware module that operates to perform certain operations as described herein.

In various embodiments, a hardware module can be implemented mechanically, or electronically. For example, a hardware module can comprise dedicated circuitry or logic that is permanently configured (e.g., as a special-purpose processor, such as a field programmable gate array (FPGA) or an application-specific integrated circuit (ASIC)) to perform certain operations. A hardware module can also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) can be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor can be configured as respective different hardware modules at different times. Software can accordingly configure a processor, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple of such hardware modules exist contemporaneously, communications can be achieved through signal transmission (e.g., over appropriate circuits and buses) that connect the hardware modules. In embodiments in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein may, in some example embodiments, comprise processor-implemented modules.

Similarly, the methods described herein can be at least partially processor-implemented. For example, at least some of the operations of a method can be performed by one or more processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or as a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers(as examples of machines including processors), these operations being accessible via a network (e.g., the network 104 of FIG) and via one or more appropriate interfaces (e.g. APIs).

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments. It is contemplated that any features of any embodiments disclosed herein can be combined with any other features of any other embodiments disclosed herein. Accordingly, these any such hybrid embodiments are within the scope of the present disclosure.

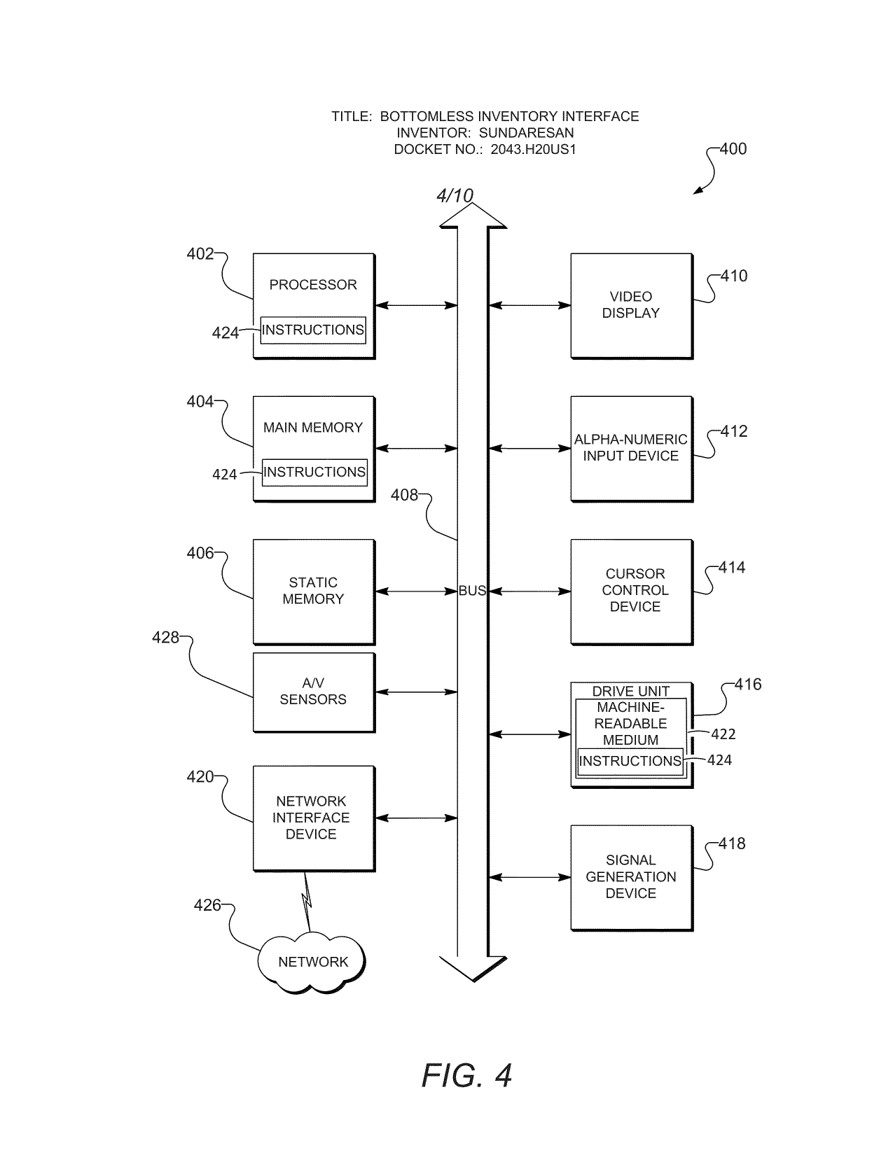

FIG. 4 is a block diagram illustrating components of a machine, according to some example embodiments, able to read instructions from a machine-readable medium and perform any one or more of the methodologies discussed herein, according to aspects of the disclosure. In particular, FIG. 4 illustrates an exemplary computer system 400 within which instructions 424 for causing the machine to perform any one or more of the methodologies discussed herein can be executed. In alternative embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 can further include a video display unit 410 (e.g., a liquid crystal display (LCD) or a cathode ray tube (CRT)). The computer system 400 also includes an alphanumeric input device 412 (e.g., a keyboard), a UI navigation (or cursor control) device 414 (e.g., a mouse), a disk drive unit 416, a signal generation device 418 (e.g., a speaker), a network interface device 420, and audio/video sensors 428 for capturing audio/video data.

The disk drive unit 416 includes a non-transitory machine-readable medium 422 on which is stored one or more sets of data structures and instructions 424 (e.g., software) embodying or utilized by any one or more of the methodologies or functions described herein. The instructions 424 can also reside, completely or at least partially, within the main memory 404 and/or within the processor 402 during execution thereof by the computer system 400, the main memory 404 and the processor 402 also constituting non-transitory, machine-readable media. The instructions 424 can also reside, completely or at least partially, within the static memory 406.

While the non-transitory machine-readable medium 422 is shown in an example embodiment to be a single medium, the term “machine-readable medium” can include a single medium or multiple media (e.g., a centralized or distributed database, and/or associated caches and servers) that store the one or more instructions 424 or data structures. The term “machine-readable medium” shall also be taken to include any tangible medium that is capable of storing, encoding, or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 424 can further be transmitted or received over a communications network 426 using a transmission medium. The instructions 424 can be transmitted using the network interface device 420 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions (e.g., instructions 424) for execution by the machine, and includes digital or analog communications signals or other intangible media to facilitate communication of such software.

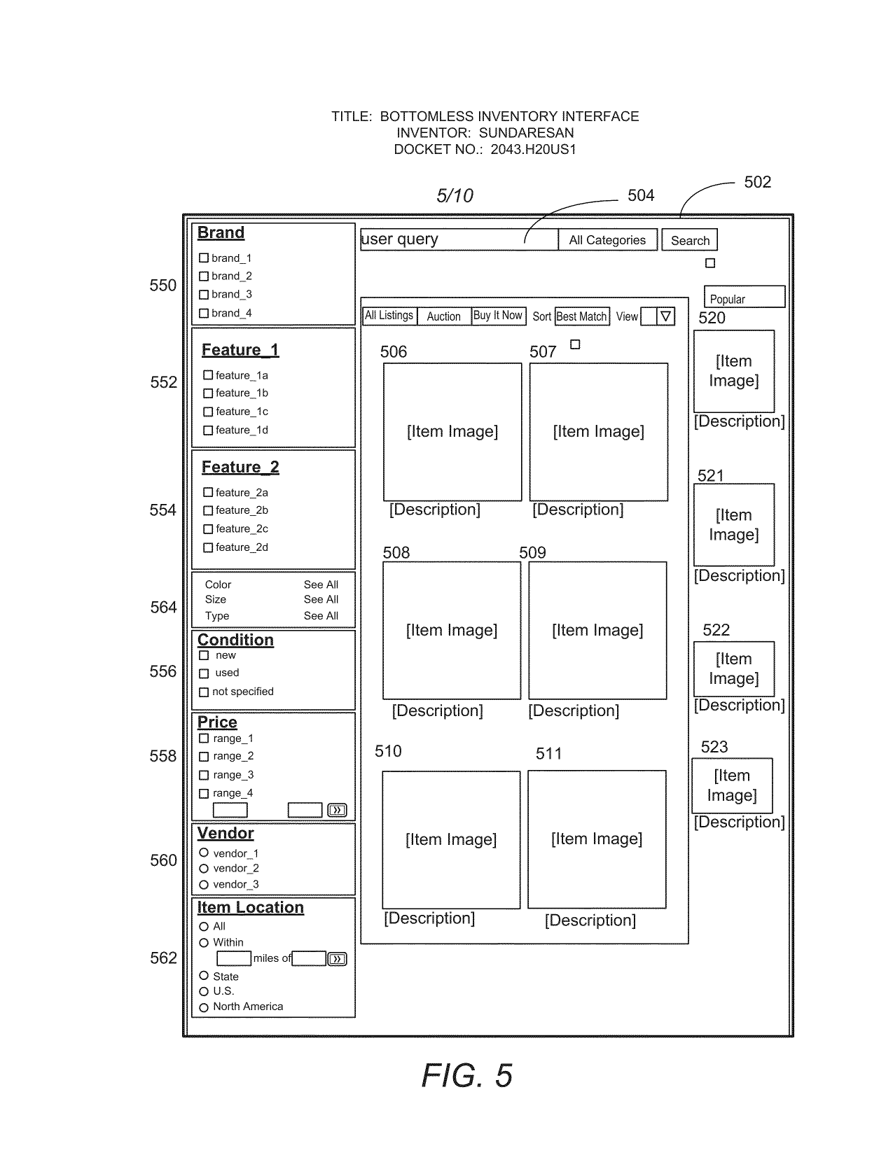

FIG. 5 illustrates webpage 502 of a publication system (e.g., an electronic marketplace) configured to publish item listings according to aspects of the disclosure. The webpage 502 can include an element, such as a text entry box 504, where the user can provide a search query to search for listings offered by the publication system. The webpage 502 and subsequent exemplary web pages illustrated and described below can alternatively comprise mobile browser or m(bile app implementations in other embodiments.

The displayed search results can include listings 506-511 that are selected (from a larger set of listings, some of which can be displayed on subsequent pages) to be displayed based, at least in part, on the listings' relevance to the search query entered into the text entry box 504. Each of the listings 506-511 is shown to include an item image and an item description; each of the item descriptions can include a title, price, brand identification, etc.

In this embodiment, a plurality of filters 550-564 and corresponding fitter values are displayed; these filters 550-564 are selectable for narrowing the scope of displayed search results for the search query entered into the text entry box 504. The filters 550-564 are shown in this example to include a brand filter 550, item feature filters 552 and 554 (labeled generically in this figure as “Feature_1” and “Feature_2”), an item condition filter 556, a price filter 558, a vendor filter 560, and an item location filter 562. The price filter 558 and the item location filter 562 are shown to accept manual user input to configure the filter 558, 562. In addition, an expandable filter set 564 is displayed to allow the user to further narrow the scope of displayed search results for the search query.

In this embodiment, listings 520-523 comprise a second set of listings that are selected for display according to a different metric than that used to select the listings 506-511. As shown in this illustration, the listings 520-523 comprise “popular” listings—i.e., said listings are selected for display based, at least in part, on popularity (i.e., different user views) in addition to relevance to the search query entered into the text entry box 504.

While a general search query entered into the text entry box 504 can result in pages of listings to display, more specific user queries (specified either through text entered into the text entry box 504, or through the selection of one or more of the filters 550-564) can result in few or zero listings to display. For example, said specific user queries can not be associated with any current or previously publishable listings (e.g., the products or items are out of stock), or can be associated with expired auctions, listings not completely aligned with user selected filter values (e.g., listings higher than a price range specified by the user via the price filter 558), etc.

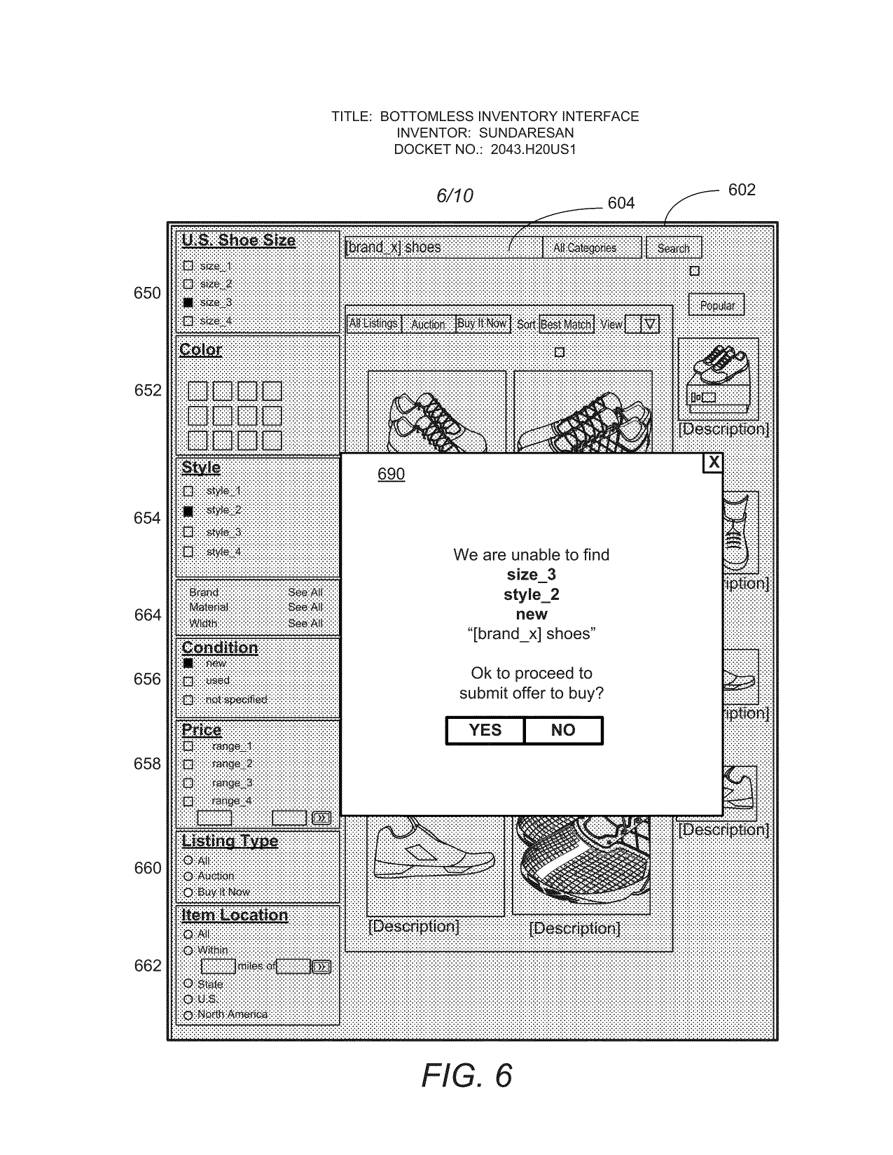

FIG. 6 is another web page 602 of the publication system displaying search results in response to a received search query 604 according to aspects of the disclosure. In this embodiment, the search query 604 is illustrated to comprise the phrase “[brand_x] shoes.”

In this embodiment, a plurality of filters 650-664 and corresponding filter values are displayed; these filters 650-664 are selectable for narrowing the scope of displayed search results for search query 604. The filters 650-664 are shown in this example to include a size filter 650, a color filter 652, an item type filter 654, an item condition filter 656, a price filter 658, a listing type filter 660, and an item location filter 662. The price filter 658 and the item location filter 662 are shown to accept manual user input to configure the filter 658, 662. In addition, an expandable filter set 664 is displayed to allow the user to further narrow the scope of displayed search results for the search query 604.

In this example, the user is shown to select filters 650, 654 and 656 to produce a narrower set of results and listings for the search query 604 (i.e., in contrast to the results produced without said filters selected). Furthermore, the user search query 604 specifies an additional item characteristic (i.e., item brand “[brand_x]”)to further limit the potential listings for satisfying the query.

In this example, the publication system has no product listings that exactly match the user's specified query at the time the search query 604 is received. In this embodiment, rather than automatically displaying an empty set of listings or listings that do not satisfy all of the user's specified filter values, a pop-up window 690 is displayed. The pop-up window 690 provides an interface where the user can specify the variation of the item that the user wants (and is currently unavailable), and prompts the user to submit an offer to buy said item. If the user selects “no,” then in some embodiments, listings that do satisfy some, but not all, of the user's specified filter values are displayed. If the user selects “yes,” an offer to buy the item having the values specified by the user search query 604 is created.

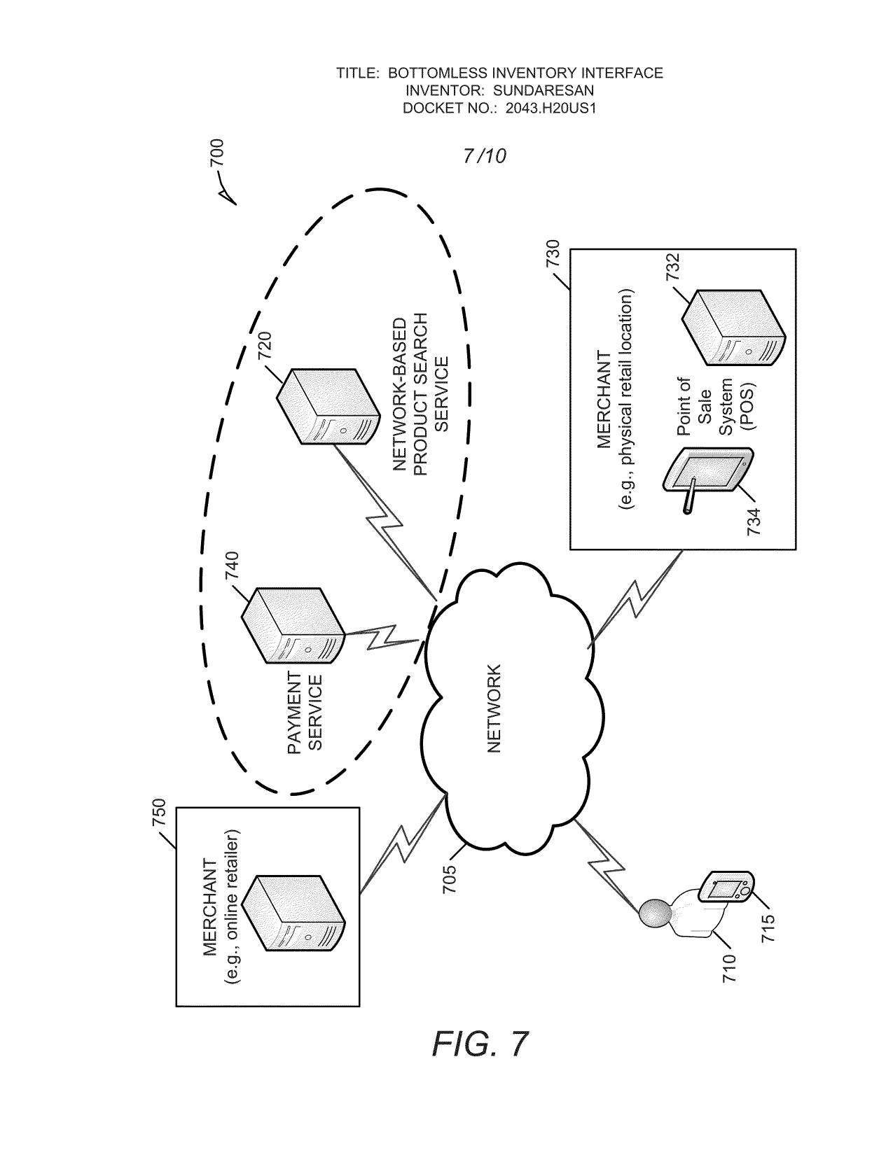

As described herein, an offer to buy a product or item establishes a real-time market (or a near real-time market) to sign up sellers to provide the product or item online or offline. FIG. 7 is an illustration of a system 700 for providing a bottomless inventory interface according to an embodiment. The system 700 can include a user 710, a network-based product search service 720, a merchant 730 having a physical retail location, an online-only merchant 750, and a network-based payment service 740, wherein all system components are communicatively coupled via a network 705.

The user 710 can connect to the network-based product search service 720 via a mobile device 715 (e.g., smart phone, PDA, laptop, a wearable computing device such as an HUD device, or any similar mobile electronic device capable of some form of data connectivity). In this embodiment, the merchant 730 having a physical retail location can utilize various computer systems, such as an inventory system 732 or a point of sale (POS) system 734, among others.

The network-based product search service 720 can interact with any of the systems used by the merchants 730 and 750 for operation of the merchants' retail or service business. For example, the network-based product search service 720 can work with both the POS system 734 and inventory system 732 of the merchant 730 to obtain access to inventory available at individual retail locations. Additionally, the network-based payment service 740 can also interact with the merchants 730 and 750, enabling the merchants 730, 750 to provide payment services offered by the network-based payment service 740. Furthermore, in some embodiments, the network-based product search service 720 can comprise a publication system that publishes listings as an ad space for vendors to purchase (e.g., a comparison shopping engine (CSE)).

As discussed above, the user 710 can be presented with an “out of inventory” type of scenario for both the online merchant 750 and the offline merchant 730. For example, the user 710 can execute a search via the network-based product search service 720 and receive no usable results due to lack of inventory from online merchant 750 and offline merchant 730. This search can be a web browser-based search, such as those discussed above with respect to FIG. 5 and FIG. 6. In another example, the user can be at the physical retail location of the merchant 730, not find the exact product the user is searching for (i.e., an article of clothing that is the wrong size, color, etc.), and submit an image-based search to the network-based product search service 720 (e.g., an image of the product via a real-time image feed from the mobile device 715, an image of a related bar code or Quick Response (QR) code capture via the mobile device 715, etc.).

Embodiments can provide an interface where the user 710 can specify the characteristics of the product of interest and run a real time market to sign up sellers to provide the product online or offline. For example, the user can submit an offer to buy a product (alternatively referred to as a want-to-buy (WTB) offer) to the network-based product search service 720. In some embodiments, the user makes a payment to the payment service 740 with the offer; in other embodiments, the offer to buy the product can comprise a reverse auction, a fixed-price listing, or a bidding fee listing (wherein all submitted bids, including bids not eventually accepted, are accompanied by a fee). The offer to buy is then transmitted in real-time or near real-time to other merchants (not shown) to determine if any merchant is willing to fulfill the offer by selling the product to user 710. In some embodiments, the merchants 730 and 750 can also receive the offer to sell and can decide to fulfill the offer by selling the product to user 710 (e.g., by ordering additional inventory and shipping the product directly to the user 710, by ordering the product from another vendor, by ordering additional inventory in response to receiving multiple offers to buy the product from different users, etc.).

Said system components can communicate via any networking framework. For example, the Open System Interconnection (OSI) model defines a networking framework to implement protocols in seven layers. The seven layers, from hardware to application layers, comprise: Layer 1 (physical layer), Layer 2(data link layer), Layer 3 (network layer), Layer 4 (transport layer), Layer 5 (session layer), Layer 6 (presentation layer), and Layer 7 (application layer).

The physical layer conveys bit data via network links (e.g., wired link, wireless links) at an electrical and mechanical level. The physical layer comprises hardware for sending and receiving data on a carrier, including semiconductor components, wires, cables, cards and other physical structures. The data link layer can encode and decode data packets into bits, as well as manage transmission protocol and error handling for the physical layer. The network layer provides switching and routing functionalities, creating logical paths for transmitting data from component to component. The network layer can further execute addressing, internetworking, error handling, congestion control and packet sequencing functions. The transport layer provides transparent transfer of data between end systems and is responsible for end-to-end error recovery and flow control, while the session layer can establish, manage and terminate connections between applications.

The presentation layer provides independence from differences in data representation (e.g., encryption) by translating from an application format to a network format, and vice versa. In other words, the presentation layer transforms data into a form that is acceptable to the application layer. This layer can format and encrypt data to be sent across the network 705, providing freedom from compatibility problems between the user 710, the network-based product search service 720, the merchants 730 and 750, and the network-based payment service 740. The application layer can support computer program applications and end-user processes, such as identifying communication partners, quality of service (QoS) parameters, user authentication and privacy parameters, data syntax parameters, etc. The application layer provides application services for file transfers, e-mail and other network software services (e.g., telnet and file transfer protocol (FTP).

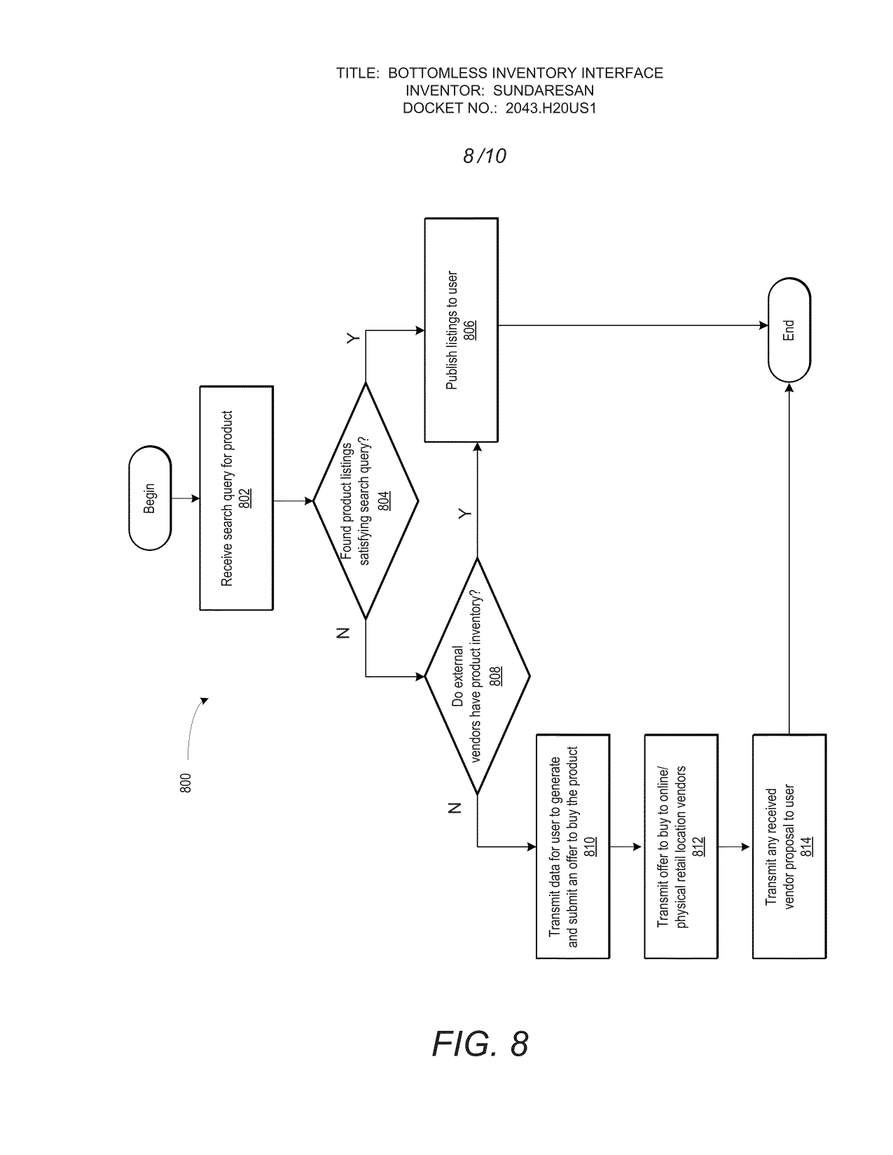

FIG. 8 illustrates an exemplary logic flow for presenting a bottomless inventory for received search queries according to aspects of the disclosure. Logical flow diagrams as illustrated herein provide examples of sequences of various process actions. Although shown in a particular sequence or order, unless otherwise specified, the order of the actions can be modified. Thus, the described and illustrated implementations should be understood only as examples, and the illustrated processes can be performed in a different order, and some actions can be performed in parallel. Additionally, one or more actions can be omitted in various embodiments; thus, not all actions are required in every implementation. Other process flows are possible.

Logic flow 800 includes executing a search for one or more product listings of a publication service in response to receiving a user query for a product (block 802). As discussed above, said user query is received from a client device—e.g., a mobile computing device; thus, said user query can comprise a text-based search query of a publication service, an image of a product, an image of a machine-readable barcode associated with the product, audio data of the user describing the product, etc.

If one or more product listings are found that satisfy the user query (block 804), then these listings are published to the user (block 806); otherwise, in this embodiment, inventory of vendors external to the publication service are queried for the product (block 808). As discussed above, in some embodiments said publication system can comprise a publication system that publishes listings as an ad space for vendors to purchase (e.g., a CSE)); if none of these vendors has published a product listing to satisfy the user's search query of block 802, listings of other vendors not related to the publication system can be queried in an attempt exhaust all possible means for satisfying the search query. If any such listings are found, they are published to the user (block 806); otherwise, in this embodiment, data is transmitted to the user to generate and submit an offer to buy the product (block 810). The offer to buy the product can comprise a reverse auction, wherein the lowest selling price is automatically accepted (in other words, the price of the product can decrease over time in contrast to a conventional auction, where the price can increase over time). In other embodiments, the offer to buy can allow for variations in the product characteristics (e.g., color, size, etc.), delivery time, price, etc., wherein the user manually accepts a given offer to sell the product.

The user-created offer to buy the product is received and subsequently forwarded to various vendors (block 812). These vendors can comprise any combination of vendors utilizing physical retail locations, online-only vendors, etc. The vendors can receive the user's offer to buy the product in real time or near-real time Any received vendor proposal to sell the product to the user is also transmitted to the user (block 814) in real time or near-real time.

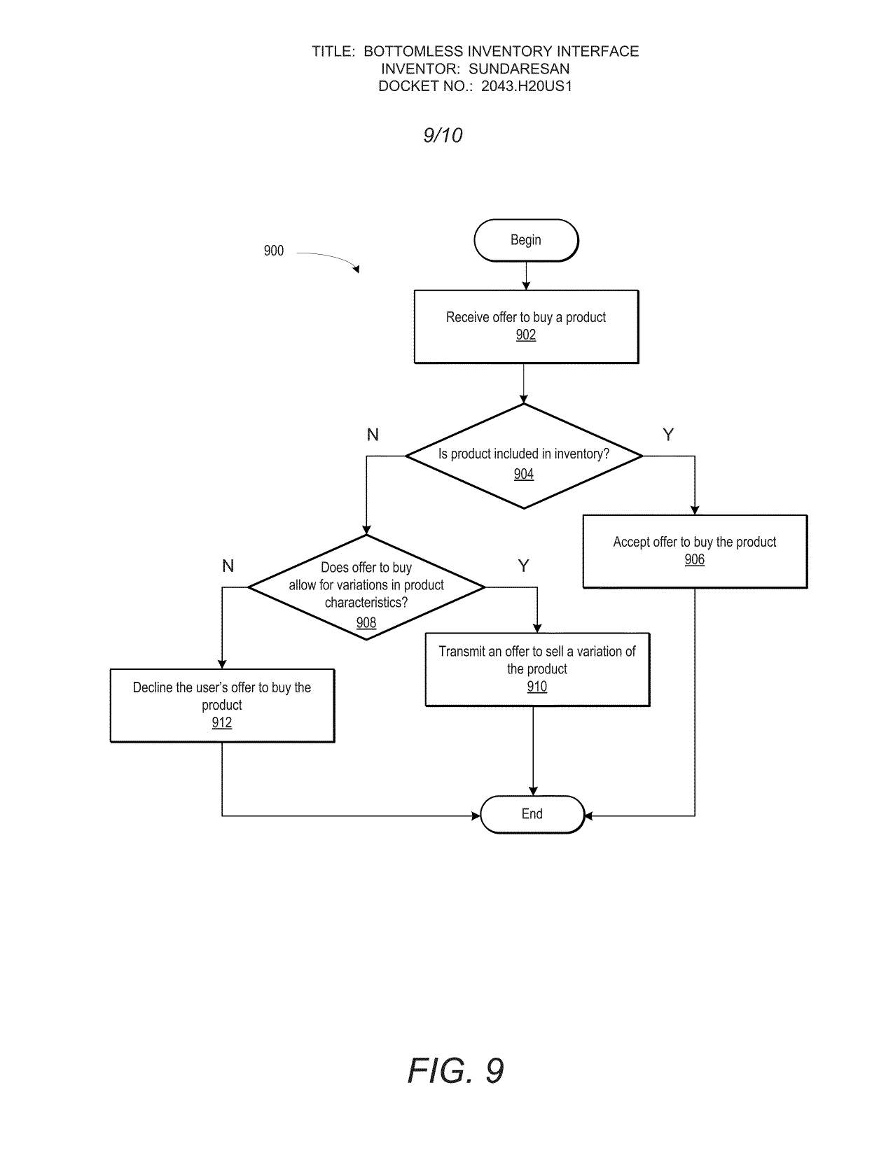

FIG. 9 illustrates an exemplary logic flow 900 for processing a received user-generated offer to buy a product according to aspects of the disclosure. In this embodiment, logic flow 900 includes receiving an offer to buy a product from a user (block 902). The vendor executes a search of its inventory to determine if the offer to buy the product can be immediately fulfilled (block 904). If the vendor possesses such inventory, the offer to buy the product can be accepted (block 906). In some embodiments, a network-based product search service can have previously searched some or the entire inventory of the vendor and determined the vendor does not have the product specified by the user.

If the user's offer to buy to product allows for variations in the characteristics of the product (e.g., color, size, etc.) (block 908), the vendor can transmit one or more listings of variations of the product immediately available (i.e., in-stock) to the user as an offer to sell (block 910). Otherwise, the vendor declines the user's offer to buy the product due to lack of inventory (block 912).

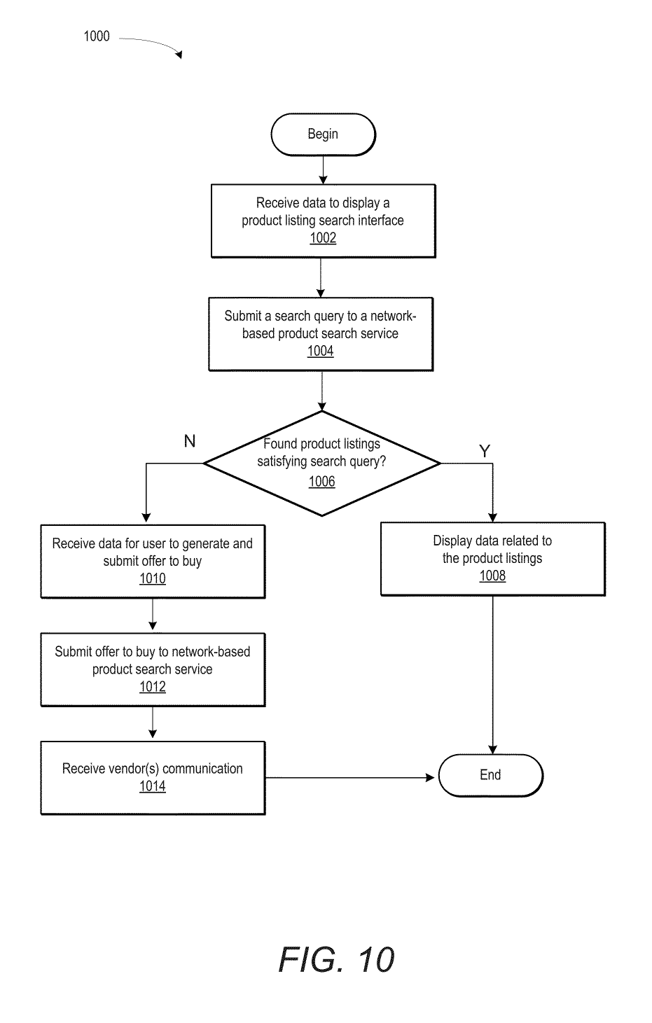

FIG. 10 illustrates an exemplary logic flow 1000 for submitting a user-generated offer to buy a product according to aspects of the disclosure. Logic flow 1000 includes a client device receiving data to display a product listing search interface to a user (block 1002). As discussed above, the product listing search interface can comprise a presentation layer for a network-based product search service, wherein the user can submit a product search comprising text, image data, audio data, etc.

The user submits a search query to the network-based product search service via the client device (block 1004). If display data for product listings that satisfy the search query is received (block 1006), then the display data is displayed to the user via the client device (1008); otherwise data is received for displaying an interface for the user to generate and submit an offer to buy the product (block 1010). The offer to buy the product allows the user to specify the variation that the user wants that is not included in the inventories that the network-based product search service has queried. The offer to buy is submitted to the network-based product search service (block 1012) for the service to identify local or partner inventory that might be available and, if none exists, run a real-time market to sign up vendors to provide the product online or offline. The client device receives any acceptances or rejections of the offer to buy from vendors (block 1014); in some embodiments, offers to sell a product similar to, but not exactly matching, the product specified in the user-submitted offer to buy can also be received and presented to the user.

Although an embodiment has been described with reference to specific example embodiments, it will be evident that various modifications and changes can be made to these embodiments without departing from the broader spirit and scope of the present disclosure. Accordingly, the specification and drawings are to be regarded in an illustrative rather than a restrictive sense. The accompanying drawings that form a part hereof show; by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A non-transitory machine-useable storage medium embodying instructions which, when executed by a machine, cause the machine to execute operations comprising:
executing a search for one or more product listings in response to receiving a user query, from a client device, for a product;
in response to identifying one or more product listings to satisfy the user query, transmitting data, for the client device to display via a graphical user interface (GUI), associated with the identified one or more product listings; and
in response to not identifying a product listing to satisfy the user query:
transmitting data, for the client device to display via the GUI, for the user to generate an offer to buy the product;
in response to receiving the offer to buy the product from the e user via the client device, transmitting the offer to buy the product to one or more vendors; and
in response to receiving at least one offer to sell the product from a vendor, transmitting data, for the client device to display via the GUI, associated with the at least one received offer to sell the product.

2. The non-transitory machine-useable storage medium of claim 1, wherein the user query includes image data related to the product.

3. The non-transitory machine-useable storage medium of claim 2, wherein the image data related to the product comprises an image of a machine-readable barcode associated with the product.

4. The non-transitory machine-useable storage medium of claim 1, wherein the user query comprises a search query from a published electronic marketplace.

5. The non-transitory machine-useable storage medium of claim 4, wherein not identifying a product listing to satisfy the user query includes identifying expired auction listings for the product.

6. The non-transitory machine-useable storage medium of claim 4, wherein the user query includes one or more filter values for narrowing a scope of the search for the product listing, and wherein not identifying a product listing to satisfy the user query includes identifying product listings for the product not satisfying one of the filter values.

7. The non-transitory machine-useable storage medium of claim 6, wherein the one or more filter values include at least one of a product characteristic filter value, a price filter value, or a product delivery filter value.

8. The non-transitory machine-useable storage medium of claim 4, wherein the operations further comprise:
in response to not identifying a product listing to satisfy the user query, executing a search of vendors not included in the published electronic marketplace for a product listing of the product for sale.

9. The non-transitory machine-useable storage medium of claim 1, wherein the offer to buy the product comprises a reverse auction.

10. The non-transitory machine-useable storage medium of claim 1, wherein transmitting the offer to buy the product to one or more vendors comprises transmitting the offer from the user when at least one other offer from another user is received.

11. A system comprising:
a network-based product search engine to:
execute a search for one or more product listings in response to receiving a user query, from a client device, for a product;
in response to identifying one or more product listings to satisfy the user query, transmit data, for the client device to display via a graphical user interface (GUI), associated with the identified one or more product listings; and
in response to not identifying a product listing to satisfy the user query:
transmit data, for the client device to display via the GUI, for the user to generate an offer to buy the product;
in response to receiving the offer to buy the product from the user via the client device, transmit the offer to buy the product to one or more vendors; and
in response to receiving at least one offer to sell the product from a vendor, transmit data, for the client device to display via the GUI, associated with the at least one received offer to sell the product;
one or more memory devices communicatively coupled to the network-based product search engine; and
one or more processors to execute the network-based product search engine.

12. The system of claim 11, wherein the user query includes image data related to the product.

13. The system of claim 12, wherein the image data related to the product comprises an image of a machine-readable barcode associated with the product.

14. The system of claim 11, wherein the user query comprises a search query from a published electronic marketplace.

15. The system of claim 14, wherein not identifying a product listing to satisfy the user query includes identifying expired auction listings for the product.

16. The system of claim 14, wherein the user query includes one or more filter values for narrowing a scope of the search for the product listing, and wherein not identifying a product listing to satisfy the user query includes identifying product listings for the product not satisfying one of the filter values.

17. The system of claim 16, wherein the one or more filter values include at least one of a product characteristic filter value, a price filter value, or a product delivery filter value.

18. The system of claim 14, wherein the network-based product search engine is to further:
in response to not identifying a product listing to satisfy the user query, execute a search of vendors not included in the published electronic marketplace for a product listing of the product for sale.

19. The system of claim 18, wherein the vendors not included in the published electronic marketplace comprise at least one of:
online vendors not included in the published electronic marketplace; or
offline vendors having one or more physical retail locations.

20. The system of claim 11, wherein the offer to buy the product comprises a reverse auction.

21. The system of claim 11, wherein the offer to buy the product comprises at least one of a fixed-price listing, or a bidding fee listing.

22. The system of claim 11, wherein the network-based product search engine is to transmit the offer to buy the product when at least one other offer from another user is received.

23. A method comprising:
executing a search for one or more product listings in response to receiving a user query, from a client device, for a product;
in response to identifying one or more product listings to satisfy the user query, transmitting data, for the client device to display via a graphical user interface (GUI), associated with the identified one or more product listings; and
in response to not identifying a product listing to satisfy the user query:
transmitting data, for the client device to display via the GUI, for the user to generate an offer to buy the product;
in response to receiving the offer to buy the product from the user via the client device, transmitting the offer to buy the product to one or more vendors; and
in response to receiving at least one offer to sell the product from a vendor, transmitting data, for the client device to display via, the GUI, associated with the at least one received offer to sell the product.

24. The method of claim 23, wherein the user query includes image data related to the product.
